(19) United States
(12) Patent Application Publication
(10) Pub. No.: US 2022/0248821 A1
(43) Pub. Date: Aug. 11, 2022

(54) ASSEMBLY COMPRISING SPECTACLES AND A CASE FOR STORING SAID THE SPECTACLES

(71) Applicant: BINOPTICS SPRL, Bruxelles (BE)

(72) Inventor: Pierre Alex, Bruxelles (BE)

(21) Appl. No.: 17/441,745

(22) PCT Filed: Mar. 22, 2019
(86) PCT No.: PCT/EP2019/057192

§ 371 Date: Apr. 27, 2022

(51) Int. Cl. A45C 11/04; G02C 5/14; G02C 5/16

(52) U.S. Cl. CPC A45C 11/04; G02C 5/16; G02C 5/146

(57) ABSTRACT

The invention relates to an assembly comprising spectacles and a case. The spectacles having a stable conformation of nominal thickness when the temples are in a storage position. The case has an upper slot opening into a compartment arranged to contain the spectacles in stable conformation. The spectacles have a resiliently constrained conformation of reduced thickness by relative approximation of the optical module and the temples when in the storage position. The upper slot of the case allows the passage of the spectacles in constrained conformation. The compartment is arranged to allow the resilient return of the spectacles to the storage conformation of and allows them to be held in the compartment by geometric interaction between the spectacles and the compartment.

### CROSS-REFERENCE TO RELATED APPLICATIONS

This application claims the benefit of International application number PCT/EP2019/057192, filed Mar. 22, 2019, the entire contents of which is incorporated herein by reference.

### TECHNICAL FIELD

The invention relates to an assembly comprising spectacles and a case for storing spectacles.

### BACKGROUND

Spectacles are known comprising an optical module intended to be disposed facing the eyes of a wearer to allow vision through same, as well as two temples each mounted in rotation on respectively an external edge of said optical module, each temple being intended to rest respectively behind an ear of the wearer to ensure the holding of said spectacles on the head of said wearer when being used.

In particular, the temples are reversibly movable between a use position, wherein they extend in a direction substantially perpendicular to a frontal plane defined by the external edges of the optical module, and a storage position, wherein they are folded behind said optical module. Such an arrangement allows to limit the space requirement of the spectacles when they are not in use, so that they can more easily be stored in a clothing pocket or a bag.

Advantageously, provision can be made of a case wherein to store the spectacles with their temples folded, which allows to protect them against impacts and/or against potentially polluting external elements such as sand and/or dust, in order to limit the risk of damage to the optical module and/or temples.

Document US-2011/0278181 describes a case of substantially planar shape, comprising an upper opening which opens into a compartment arranged to contain spectacles as described above in the storage position.

In particular, this document provides for equipping the case with an inner liner made of resiliently deformable foam in the compartment, in order to allow a slight deformation of said liner during the insertion of the spectacles in the storage position through the upper opening. Thus, once the spectacles are inserted into the compartment, the resilient return of the liner ensures that said spectacles are held in said compartment.

However, this solution is not entirely satisfactory, in that the case turns out to be relatively complex, and therefore expensive to produce. Moreover, the inner liner can be damaged with use, and in particular become permanently deformed, which compromises its long-term effectiveness, and therefore the reliability of holding the spectacles in the case.

### SUMMARY OF THE INVENTION

The invention aims at improving the prior art by proposing an assembly wherein the case and the spectacles are arranged to ensure reliably holding said spectacles in said case when they are not in use, and thus guarantee good protection of said spectacles against possible damage.

To this end, the invention provides an assembly comprising:

spectacles comprising an optical module and two temples each mounted in rotation on respectively an external edge of said optical module, said temples being reversibly movable between a use position, wherein they extend in a direction substantially perpendicular to a frontal plane defined by said external edges, and a storage position, wherein they are folded behind said optical module, said spectacles having, when the temples are in the storage position, a stable conformation of nominal thickness; and

a case comprising an upper slot opening into a compartment arranged to contain said spectacles in stable conformation, in order to allow the storage of said spectacles;

said spectacles having a resiliently constrained conformation of reduced thickness by relatively bringing together the optical module and the temples in the storage position, the upper slot being dimensioned to allow the passage through same of the spectacles in constrained conformation, said compartment being arranged so that the resilient return to the storage conformation of said spectacles allows them to be held in said compartment by geometric interaction between said spectacles and said compartment.

### BRIEF DESCRIPTION OF THE DRAWINGS

Other features and advantages of the invention will become apparent from the following description, made with reference to the appended figures, wherein:

FIGS. 1a and 1b show a front view of spectacles of an assembly according to an embodiment of the invention, respectively in the use position (FIG. 1a) and in the storage position (FIG. 1b);

FIGS. 2a and 2b show a top view of the spectacles of FIGS. 1a and 1b, respectively in the use position (FIG. 2a) and when folding the temples to the storage position (FIG. 2b);

FIG. 3 shows a front view of a case of an assembly according to one embodiment of the invention;

FIG. 4 shows in perspective and laid flat an assembly comprising the case of FIG. 3 and the spectacles of FIGS. 1a, 1b, 2a, 2b in the storage position;

FIGS. 5a, 5b and 5c show in front view (FIG. 5a) and in perspective seen from the front (FIGS. 5b and 5c) the assembly of FIG. 4 according to different steps of storage of the spectacles in the case;

FIGS. 6a, 6b and 6c show the assembly of FIG. 4 with the spectacles stored in the case, respectively in front view with the spectacles shown in dotted lines (FIG. 6a), in perspective seen from the front (FIG. 6b) and in perspective with said assembly laid flat (FIG. 6c);

FIG. 7 shows in perspective seen from above a case according to an alternative embodiment of the previous figures.

### DETAILED DESCRIPTION OF THE DRAWINGS

In relation to these figures, an assembly comprising spectacles 1 and a case 2 for storing said spectacles is described below.

The spectacles 1 comprise an optical module 3 intended to be disposed facing the eyes of a wearer to allow vision through same. In the embodiment shown, the module 3 comprises two optical units 4 connected at their respective internal edges 3a by a nose bridge 5, and each comprising a transparent wall through which the vision takes place.

In this description, the terms of positioning in space are taken with reference to the position of the spectacles 1 relative to the face of a wearer who has put on said spectacles. In particular, the term “rear” relates to an arrangement facing the face and the term “front” relates to an arrangement opposite the face. Moreover, the terms “internal” and “external” relate to arrangements respectively close to and remote from the nose of the wearer.

In a known manner, the transparent walls of the optical units 4 can be adapted to the vision of the wearer, in particular to correct vision defects such as myopia, hyperopia, astigmatism and/or presbyopia. They can also be designed to protect the wearer's eyes against light, in particular solar light and/or the light emitted by television and/or computer screens (called “blue light”), and/or have been subjected to a treatment adapted for preventing certain undesirable effects which may hinder the vision of the wearer, for example an anti-fog, anti-scratch, anti-reflection and/or anti-static treatment.

In order to be able to be held on the wearer's head, the spectacles 1 comprise two temples 6 each mounted in rotation on respectively an external edge 3b of the optical module 3, said temples being reversibly movable between:

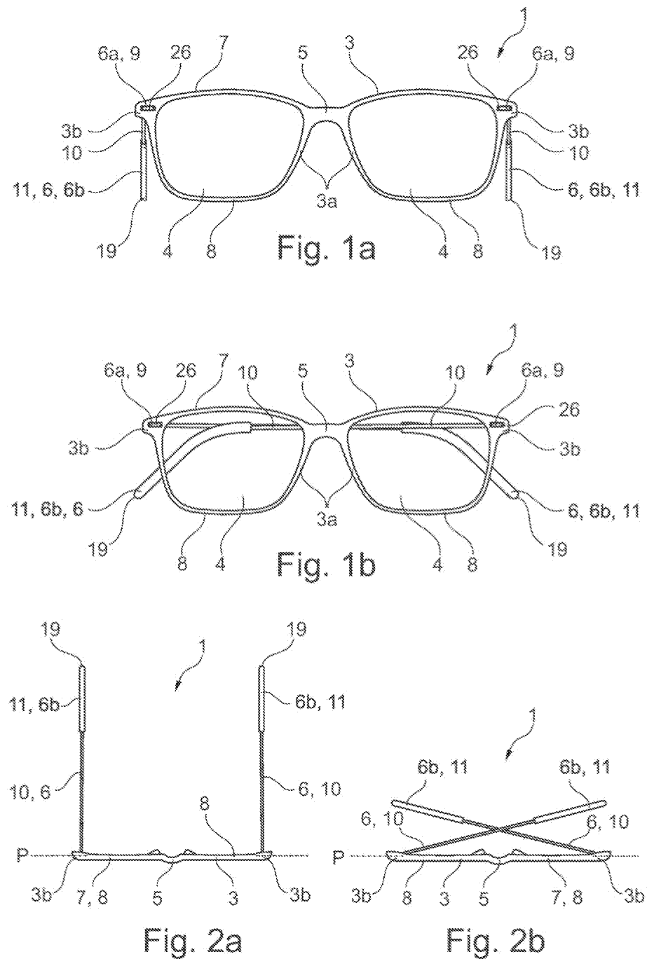

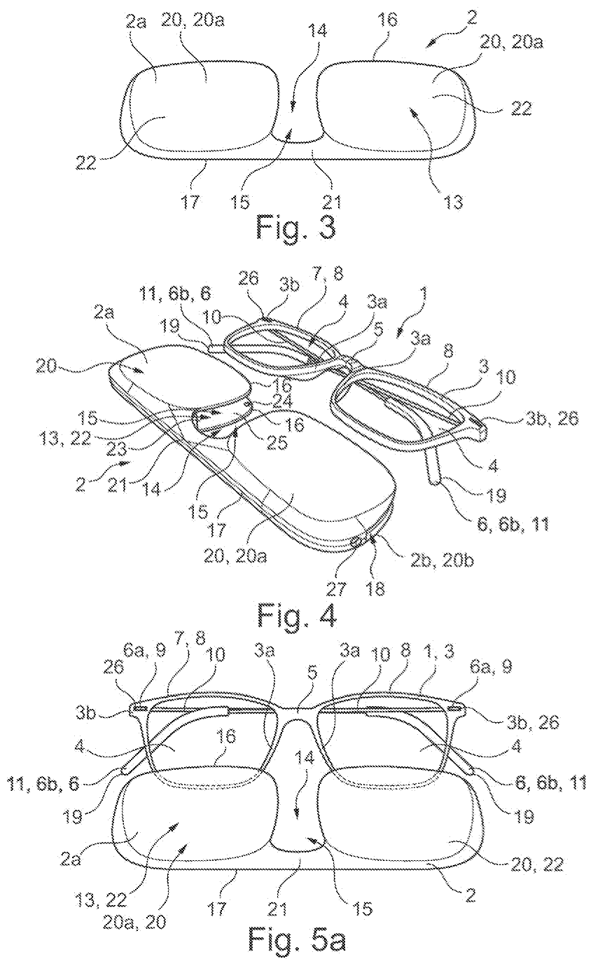

a use position, wherein they extend in a direction substantially perpendicular to a frontal plane P defined by said external edges, in order to be able to be disposed behind respectively an ear of the wearer (FIGS. 1b, 2a); and

a storage position, wherein they are folded behind said optical module, in order to limit the space requirement of the spectacles 1 to facilitate their storage in a clothing pocket or a bag (FIGS. 1a, 2b, 4).

In the figures, the optical module 3 comprises a frame 7 which has two rims 8 each respectively surrounding an optical unit 4, the nose bridge 5 being fixed to the respective internal edges 3a of said rims, and each temple 6 being mounted in rotation on the external edge 3b of one of said rims respectively.

In particular, the nose bridge 5 is formed integrally with the rims 8, which allows to facilitate the manufacture of the frame 7, and therefore of the spectacles 1.

Alternatively, the rims 8 may only partially surround the optical units 4, depending on the aesthetic effect desired for the spectacles 1. Moreover, the optical module 3 may be without a frame, the nose bridge 5 and the temples 6 being in this case mounted directly on the internal and external edges of the optical units 4 respectively.

In relation to FIGS. 2a and 2b, the optical module 3 is inscribed in the frontal plane P defined by its external edges 3b, in order to allow a reduction of the thickness of the spectacles 1 in the storage position. Alternatively, the optical module 3 can have a curved shape to improve the peripheral vision of the wearer through the spectacles 1.

Each temple 6 is provided at its proximal end 6a with a hook 9 mounted in rotation on an axis equipping the external edges 3b of each rim 8. In particular, to reduce the thickness of the spectacles 1 in the storage position, the axes are integrated into the thickness of the optical module 3, in particular by being embedded in the frame 7.

To facilitate the mounting of the hook 9 on an axis embedded in the frame 7, each external edge 3b has a recess 26 opening onto the front and the rear of said frame, and through which said axis is accessible for performing this mounting. Moreover, for aesthetic reasons, a clip, in particular made of metal, can be inserted on the front side of each recess 26 to obstruct it, in particular to conceal the mounting of the hook 9 on its axis of rotation.

In the figures, each temple 6 comprises a body 10 made of a metal wire, the proximal end 6a of said body being folded on itself to form the hook 9 allowing it to be mounted in rotation on the frame 7.

Moreover, each temple 6 comprises a distal portion 6b intended to rest at the rear of an ear of the wearer respectively, said distal portion being curved downwards to improve the holding of the spectacles on the head of said wearer, in particular to prevent the falling of said spectacles when said wearer leans his face down. To improve the comfort of the wearer, each distal portion 6b is provided with a liner 11, in particular made of plastic material, which is associated by over-moulding on the body 10 made of metal wire.

The spectacles 1 have, when they are in the storage position, a stable conformation of nominal thickness and a resiliently constrained conformation of reduced thickness by relatively bringing together the temples 6 and of the optical module 3.

For this purpose, the temples 6 and/or the optical module 3 can be made at least partially of a resiliently deformable material. In particular, in the embodiment shown, making the temples 6 from a metal wire allows such a deformation. Furthermore, the frame 7 and/or the nose bridge 5 can also be made of a resiliently deformable material.

To allow storage of spectacles 1, the assembly comprises a case 2 comprising an upper slot 12 opening into a compartment 13 arranged to contain said spectacles in stable conformation.

In particular, the case 2 has a substantially planar shape and a reduced thickness, which allows to limit its space requirement, and thus to facilitate its storage in a garment pocket or a bag.

Advantageously, the case 2 can be made of a polymer material having sufficient rigidity to ensure the protection of the stored spectacles. In particular, the case 2 can be made of two materials, with an outer shell made of rigid polymer material to ensure the rigidity of the assembly and protect the spectacles 1 against impacts, and an inner liner made of a more flexible polymer material to ensure the protection of the optical units 4.

The slot 12 is dimensioned to allow the passage through same of the spectacles 1 in constrained conformation, the compartment 13 being arranged so that the resilient return to the storage conformation of said spectacles allows them to be held in said compartment by geometric interaction between said spectacles and said compartment.

Advantageously, the compartment 13 has a transverse dimension which is sufficient to allow the resilient return in stable conformation of the spectacles 1 inside said compartment, so that the storage conformation of said spectacles corresponds to their stable conformation. Alternatively, the compartment 13 can be arranged to hold the spectacles 1 in a resiliently constrained conformation, but to a lesser extent than the constrained conformation necessary for the passage of said spectacles through the slot 12.

Thus, a case 2 is proposed which, in relation to spectacles 1 that can be resiliently constrained in thickness, allowing to reliably hold said spectacles in its compartment 13 when they are not in use, and therefore to guarantee good protection of said spectacles against possible damage, while being simple and inexpensive to manufacture.

In particular, the spectacles are constrained manually, in particular by pressure between two fingers, advantageously before the arrangement of the spectacles 1 in the case 2. For this purpose, the compartment 13 comprises a central recess 14 arranged to allow the manual holding of the spectacles 1 in constrained conformation in the compartment 13, in order to allow their storage or their extraction from said compartment.

Advantageously, the recess 14 is arranged to receive the nose bridge 5 and the portions of the temples 6 that are stored facing said bridge. Thus, to store or remove the spectacles 1 from the case 2, the wearer preferably interacts with the nose bridge 5, which allows him in particular not to place his fingers on the optical units 4, and therefore to avoid leaving fingerprints on said optical units which may impede the vision of said wearer when he puts on said spectacles.

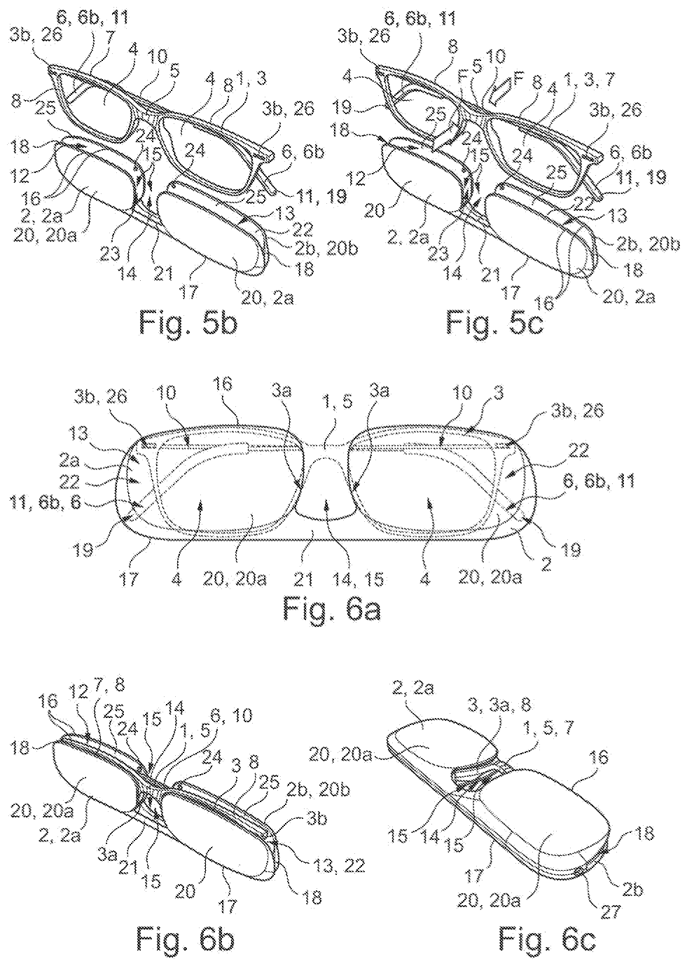

In order to be able to store the spectacles 1, the wearer, after having folded the temples 6 behind the optical module 3, manually grips said spectacles at the nose bridge 5 to place them in a constrained conformation, as represented by the arrows F on FIG. 5c. Then, the wearer passes the spectacles 1 thus constrained through the slot 12 of the case 2 to place them in the compartment 13, by placing his fingers gripping said spectacles in the central recess 14. Finally, once the spectacles 1 are disposed in the compartment 13, the wearer releases them by spreading his fingers, in order to allow their resilient return to the storage conformation.

Likewise, in order to be able to extract the spectacles 1 from the case, the wearer grips the nose bridge 5 and the portions of the temples 6 extending in the central recess 14 to dispose them in a constrained conformation, then passes said spectacles thus constrained through the slot 12.

The case 2 comprises a front face 2a and a rear face 2b which are spaced from each other to form the compartment 13 therebetween, each of said faces having a central notch 15 which are disposed facing each other to form the recess 14.

In particular, the compartment 13 can be arranged to be able to receive the spectacles 1 by disposing indifferently the front or the rear of said spectacles against the front face 2a or the rear face 2b of said compartment, that is to say without having to respect a particular direction, which allows to facilitate the storage of said spectacles in the case 2. Furthermore, to improve the ergonomics of the spectacles 1/case 2 assembly, the front 2a and rear 2b faces may have external surfaces identical in appearance.

The front 2a and rear 2b faces each have an upper edge 16 between which the slot 12 is formed and, opposite said slot, said front and rear faces are connected by a lower closing border 17 of the compartment 13. Furthermore, the front 2a and rear 2b faces form therebetween, on each side of the case 2, external edges 18 which are open between said faces from the closing border 17 to the slot 12, which allows to facilitate storage or extraction of the spectacles 1 by limiting the friction between the case 2 and the external edges 3b of said spectacles and/or the distal end 19 of the temples 6.

In the embodiment shown, the case 2 comprises two modules 20 for respectively storing an optical unit 4 interconnected by a lower bridge 21 disposed opposite the slot 12, the recess 14 being formed between the modules 20.

Each module 20 comprises a front wall 20a and a rear wall 20b respectively originating from the front face 2a and the rear face 2b of the case 2, and spaced from each other to form therebetween a housing 22 for receiving respectively an optical unit 4 and the portions of the temples 6 disposed facing said optical unit.

The walls 20a, 20b of each module 20 form therebetween an internal edge 23 which is at least partially open, in order to be able to dispose the spectacles 1 entirely in the compartment 13. In the figures, the internal edge 23 of each module 20 is open from the lower bridge 21 to the slot 12, in order to avoid friction against said module of the internal edge 3a of the corresponding optical unit 4 and/or portions of the temples 6 stored facing said optical unit.

According to one embodiment, the case 2 can be arranged to resiliently deform by pressing the spectacles 1 to confirm storage in the compartment 13, in order to ensure that the spectacles 1 are held in said compartment. In particular, the opening of the external edges 18 contributes to the deformation of the case 2 by pressing the spectacles 1 in the compartment 13.

The compartment 13 thus deformed may have a width which is substantially equal to the nominal thickness of the spectacles 1 in stable conformation, in order to ensure that said spectacles are held in place by friction in said compartment.

Furthermore, the slot 12 may have a width which is comprised between the respective thicknesses of the spectacles in nominal conformation and in constrained conformation, for example being of the order of the thickness of the spectacles 1 in constrained conformation.

Moreover, the slot 12 may have a width which is less than that of the compartment 13, in order to secure any untimely sliding through said slot of said spectacles stored in the compartment 13, and in particular the fall by gravity of said spectacles out of the case 2 when the latter is oriented with the slot 12 facing downwards.

For this purpose, at least one of the upper edges 16 can be curved internally to reduce the width of the slot 12 relative to that of the compartment 13.

The compartment 13 may also comprise at least one stud 24 projecting internally in said compartment, said stud being arranged to retain the spectacles 1 in storage conformation in said compartment by geometric interaction with the temples 6 and/or the optical module 3.

Such a stud 24 can be formed near the upper slot 12, so that an upper part of the optical module 3 and/or the temples 6 rest vertically under said stud when the spectacles 1 are stored in the compartment 13 in storage conformation.

In particular, the dimensions of the compartment 13 and/or spectacles 1 can be arranged so that said spectacles are spaced from said studs by a distance at least equal to 5 mm when the case 2 containing said spectacles is disposed with the slot 12 facing upwards. Thus, the spectacles 1 bear against the studs 24 only when the spectacles 1 move in the compartment 13, for example under the effect of gravity when the assembly is oriented with the slot 12 facing downwards. Alternatively, the spectacles 1 can bear permanently under the studs 24, in order to limit their movements in the compartment 13, and thus improve their protection.

In the embodiment shown, the front 20a and rear 20b walls of each storage module 20 each has an inner surface 25 against which the optical unit 4 or the portions of the temples 6 stored facing said optical unit is (are) intended to be disposed, in particular in frictional contact, when the spectacles 1 are stored in the compartment 13, a stud 24 being formed on at least one of said surfaces.

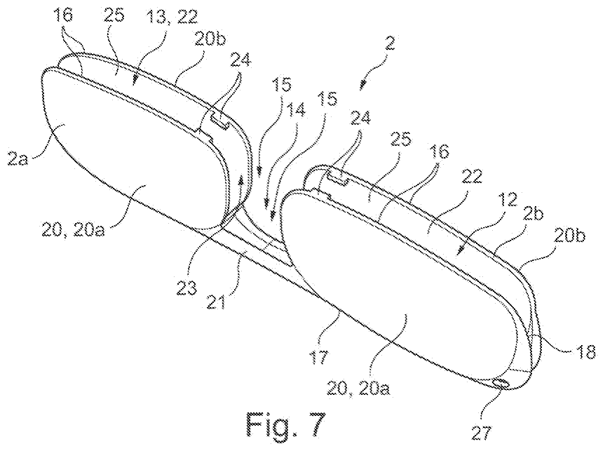

In particular, as shown in FIG. 7, such a stud 24 is formed on each of the aforementioned inner surfaces 25, a front stud 24 being further disposed facing a rear stud 24.

The stud(s) 24 has (have) transverse and/or longitudinal dimensions large enough to allow the spectacles 1 to be retained in the compartment 13, in particular when the case 2 is oriented with the slot 12 downwards. Thus, it is possible to provide studs 24 of substantially cylindrical shape in the transverse direction, as shown in particular in FIGS. 4, 5b, 5c, 6b and 6c, or of elongated shape in the longitudinal direction, as shown in FIG. 7.

To allow the transport of the assembly, the case 2 comprises means 27 to allow the attachment of a carrying device, such as for example a cord, a wrist strap or a carabiner. Thus, the wearer can easily transport the assembly while keeping it within reach of use, while keeping their hands free, for example by hanging it around their neck (thanks to a cord) or from their belt (thanks to a carabiner). In the embodiment shown, the attaching means comprise an orifice 27 formed on an external edge 18 and opening into the compartment 13.

What is claimed is:

1. An assembly comprising:
spectacles comprising an optical module having a first and a second external edge and two temples each mounted in rotation on respectively the first and the second external edge of the optical module, the temples being reversibly movable between a use position, wherein the temples extend in a direction substantially perpendicular to a frontal plane defined by the external edges, and a storage position, wherein they are folded behind the optical module, the spectacles having, when the temples are in the storage position, a stable conformation of nominal thickness; and
a case comprising an upper slot opening into a compartment configured to contain the spectacles in stable conformation, in order to allow the storage of the spectacles;
the assembly wherein the spectacles have a resiliently constrained conformation of reduced thickness by relatively bringing together the optical module and the temples in the storage position, and in that the upper slot is dimensioned to allow the passage of the spectacles in the resiliently constrained conformation, the compartment being configured to allow the resilient return of the spectacles from the resiliently constrained conformation to the storage conformation of the spectacles allows the spectacles to be held in the compartment by geometric interaction between the spectacles and the compartment.

2. The assembly according to claim 1, wherein the compartment comprises a central recess configured to allow the manual holding of the spectacles in the resiliently constrained conformation in the compartment, in order to allow the spectacles storage or extraction from the compartment.

3. The assembly according to claim 2, wherein the case comprises a front face and a rear face which are spaced from each other to form the compartment therebetween, each of the faces having a central notch which are disposed opposite each other to form the central recess.

4. The assembly according to claim 3, wherein the front and rear faces form the upper slot therebetween and, opposite the slot, the front and rear faces are connected by a lower closing border of the compartment.

5. The assembly according to claim 4, wherein the front and rear faces form therebetween external edges on each side of the case, the external edges being open between the faces from the closing border to the upper slot.

6. The assembly according to claim 1, wherein the optical module comprises two optical units connected at their respective internal edges by a nose bridge, the two temples being mounted in rotation on the respective external edge of each of the two optical units.

7. The assembly according to claim 6, wherein the central recess is arranged to receive the nose bridge and the portions of the temples arranged facing the bridge.

8. The assembly according to claim 6, wherein the case comprises two modules for respectively storing an optical unit, the modules being interconnected by a lower bridge disposed opposite the upper slot.

9. The assembly according to claim 8, wherein each storage module comprises a front wall and a rear wall which are spaced from each other to form therebetween a housing for receiving respectively an optical unit and portions of the temples stored opposite the optical unit.

10. The assembly according to claim 6, wherein the optical module comprises a frame which has two rims each at least partially surrounding respectively an optical unit, the nose bridge being fixed to the respective internal edges of the rims and each temple being mounted in rotation on the external edge of one of the rims respectively.

11. The assembly according to claim 1, wherein the temples or the optical module are made at least partially of a resiliently deformable material.

12. The assembly according to claim 1, wherein the case is arranged to resiliently deform by pressing the spectacles in storage conformation in the compartment, in order to ensure that the spectacles are held in the compartment.

13. The assembly according to claim 1, wherein the slot has a width which is less than width of the compartment.

14. The assembly according to claim 1, wherein the compartment comprises at least one stud projecting internally in the compartment, the stud being arranged to retain the spectacles in storage conformation in the compartment by geometric interaction with the temples or the optical module.

15. The assembly according to claim 9, wherein the front and the rear walls of each storage module each has an inner surface, a stud being formed on at least one of the inner surfaces.

16. The assembly according to claim 1, wherein the temples are provided at their proximal end with a hook mounted in rotation on an axis equipping each of the external edges of the optical module.

17. The assembly according claim 1, wherein the case comprises an opening for the attachment of a device for carrying the assembly.
